(19) United States
(12) Patent Application Publication
(10) Pub. No.: US 2011/0161142 A1
(43) Pub. Date: Jun. 30, 2011

(54) TARGETED RESTRICTION OF ELECTRONIC OFFER REDEMPTION

(75) Inventors: MELISSA WOOD DUNN, Woodenville, WA (US); DANIEL SALVATORE SCHIAPPA, Bedford, NH (US); MELISSA FRENCH, Lynnwood, WA (US)

(73) Assignee: MICROSOFT CORPORATION, Redmond, WA (US)

(21) Appl. No.: 12/651,131

(22) Filed: Dec. 31, 2009

(51) Int. Cl. G06Q 30/00

(52) U.S. Cl. 705/14.1

(57) ABSTRACT

Methods for permitting advertising entities to cap the distribution of electronic offers or coupons and to monitor active electronic advertising campaigns and receive real-time feedback on the success thereof are provided. Advertising entities are further permitted to modify electronic advertising campaigns, while they are active, based upon at least one success metric. Permitting advertising entities to cap distribution of electronic offers and to monitor and modify electronic advertising campaigns, while they are active, provides increased control to advertising entities that elect to advertise electronically.

### BACKGROUND

Coupons have been around for decades in the print media. More recently, coupons have begun to be distributed electronically. Electronic coupons present unique challenges, however, including limiting distribution in general or to specific individuals and monitoring the rate of coupon distribution such that an advertising entity's distribution, and potential coupon redemption, expectations are not exceeded.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to permitting advertising entities to cap the distribution of electronic offers or coupons. Embodiments of the present invention further relate to permitting advertising entities to monitor active electronic advertising campaigns and receive real-time feedback on the success thereof. Still further, embodiments of the invention permit advertising entities to modify electronic advertising campaigns, while they are active, based upon at least one success metric. For instance, an advertising entity may receive information indicating that 30% more discount coupons have been served in a particular time period than expected and, accordingly, may alter the advertising campaign to bring it more in alignment with expectations. Permitting advertising entities to cap distribution of electronic offers and to monitor and modify electronic advertising campaigns, while they are active, provides increased control to advertising entities that elect to advertise electronically.

### BRIEF DESCRIPTION OF THE DRAWINGS

Embodiments of the present invention are described in detail below with reference to the attached drawing figures, wherein:

FIG. 1 is a block diagram of an exemplary computing environment suitable for use in implementing embodiments of the present invention;

FIG. 2 is a block diagram of an exemplary computing system in which embodiments of the invention may be employed;

FIG. 3 is a flow diagram showing a method for receiving a client request for an electronic offer and checking any distribution rules associated with the relevant advertising campaign before serving the requested offer, in accordance with an embodiment of the present invention;

FIG. 4 is a flow diagram showing a method for checking distribution rules associated with an advertising campaign upon receiving a ‘save’ request for an electronic offer, in accordance with an embodiment of the present invention;

FIG. 5 is a flow diagram showing a method for minting an electronic offer associated with an advertising campaign upon receiving a ‘redeem’ request for the offer, in accordance with an embodiment of the present invention;

FIG. 6 is a flow diagram showing a method for presenting electronic offers with share and/or trade indicators, in accordance with an embodiment of the present invention;

FIG. 7 is a flow diagram showing a method for checking distribution rules associated with an advertising campaign upon receiving a request to share or trade an electronic offer, in accordance with an embodiment of the present invention;

FIG. 8 is a flow diagram showing a method for sharing or trading an electronic offer, in accordance with an embodiment of the present invention;

FIG. 9 is a flow diagram showing a method for targeted restriction of electronic offer redemption, in accordance with an embodiment of the present invention;

FIG. 10 is a flow diagram showing a method for performing targeted restriction of electronic offer redemption, in accordance with an embodiment of the present invention; and

FIG. 11 is a flow diagram showing a method for targeted restriction of electronic offer redemption, in accordance with another embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are generally directed to permitting advertising entities to cap the distribution of electronic offers or coupons. As utilized herein, the terms “offer,” “offers,” “coupon,” and “coupons” are used interchangeably to refer to any offering associated with an electronic advertising campaign, whether or not such offers are “coupons” in the traditional sense. Further, embodiments of the present invention are directed to permitting advertising entities (or a person or entity associated therewith) to monitor electronic advertising campaigns and, while the campaign is active, permitting the advertising entities to modify electronic advertising campaigns based upon at least one success metric. For instance, an advertising entity may receive information indicating that 30% more discount coupons have been served in a particular time period than expected and, accordingly, may cease to distribute the particular discount coupons, may alter the amount saved upon redeeming the particular discount coupon, may decrease the rate at which the particular discount coupon is distributed, may elect to serve the discount coupon to only a targeted group of consumers, or the like. Permitting advertising entities to cap distribution of electronic offers and to monitor and modify electronic advertising campaigns, while they are active, provides increased control to advertising entities that elect to advertise electronically.

Accordingly, in one aspect, an embodiment of the present invention is directed to one or more computer-readable storage media storing computer-useable instructions that, when used by one or more computing devices, causes the one or more computing devices to perform a method for targeted restriction of electronic offer redemption. The method includes receiving a request from a first user to view an electronic offer (e.g., an electronic coupon), determining whether the first user satisfies at least one consumer targeting parameter and determining whether fulfilling the request violates an offer detail associated with the electronic offer. Upon determining that the first user satisfies at least one consumer targeting parameter and that fulfilling the request does not violate an offer detail associated with the electronic offer, the method further includes associating a pseudo-anonymous identifier with the electronic offer, the pseudo-anonymous identifier associating the electronic offer with the first user, and serving the electronic offer having the pseudo-anonymous identifier associated therewith to a computing device associated with the first user.

In another embodiment, an aspect of the invention is directed to one or more computer-readable media storing computer-useable instructions that, when used by one or more computing devices, causes the one or more computing devices to perform a method for targeted restriction of electronic offer redemption. The method includes receiving information from an advertising entity, the information being associated with an advertising campaign, the advertising campaign including at least one offer (e.g., a coupon), and the at least one offer having one or more offer details associated therewith (e.g., the value of a coupon). The method further includes activating the advertising campaign in accordance with the one or more offer details. While the advertising campaign is active, the method further includes providing to the advertising entity information associated with at least one success metric of the advertising campaign (i.e., any quantitative value that may aid the advertising entity in judging the success or failure of the advertising campaign) and receiving a change to the at least one of the one or more offer details associated with the advertising campaign to create a modified advertising campaign. Still further, the method includes terminating the advertising campaign and activating the modified advertising campaign.

A further embodiment of the present invention is directed to a method for targeted restriction of electronic coupon redemption. The method includes receiving a request from a first user to view an electronic coupon associated with an advertisement and receiving information regarding how the advertisement was received by the first user (e.g., directly from an advertising entity, through a share with another user, or through a share from another user). The method further includes utilizing a first computing process to determine whether the first user satisfies at least one consumer targeting parameter associated with the electronic coupon (e.g., the first user is in a specified location when the request to view the electronic coupon is received) and utilizing a second computing process to determine whether fulfilling the request violates an offer detail associated with the electronic coupon (e.g., a maximum number of offers have been served prior to fulfilling the instant request). Upon determining that the first user satisfies at least one consumer targeting parameter associated with the electronic coupon and that fulfilling the request does not violate an offer detail associated with the electronic coupon, the method further includes utilizing a third computing process to associate a pseudo-anonymous identifier with the electronic offer, the pseudo-anonymous identifier associating the electronic coupon with the first user and the information regarding how the advertisement was received by the first user. Still further, the method includes presenting at least a preview of the electronic coupon. Each of the first, second and third computing processes is performed by one or more computing devices.

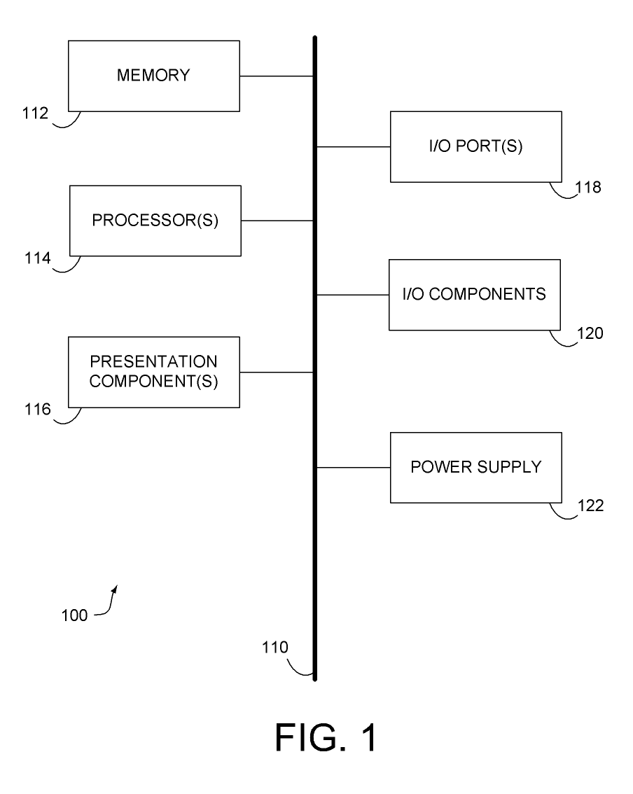

Having briefly described an overview of embodiments of the present invention, an exemplary operating environment in which embodiments of the present invention may be implemented is described below in order to provide a general context for various aspects of the present invention. Referring to the figures in general, and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, the computing device 100 includes a bus 110 that directly or indirectly couples the following devices: a memory 112, one or more processors 114, one or more presentation components 116, input/output ports 118, input/output components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media can be any available media that can be accessed by the computing device 100 and includes both volatile and nonvolatile media, removable and non-removable media implemented in any method or technology for storage of information such as computer-readable instructions, data structures, program modules or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Combinations of any of the above should also be included within the scope of computer-readable media.

The memory 112 includes computer-storage media in the form of volatile and/or nonvolatile memory. The memory may be removable, nonremovable, or a combination thereof. Exemplary hardware devices include solid-state memory, hard drives, optical-disc drives, etc. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, and the like.

As indicated previously, embodiments of the present invention are directed to permitting advertising entities to cap the distribution of electronic offers or coupons. Additionally, embodiments of the present invention are directed to permitting advertising entities to monitor active electronic advertising campaigns and receive real-time feedback on the success thereof. Embodiments of the invention further permit advertising entities to modify electronic advertising campaigns, while they are active, based upon at least one success metric. As will be described in further detail below, permitting advertising entities to cap distribution of electronic offers and to monitor and modify electronic advertising campaigns, while they are active, provides increased control to advertising entities that elect to advertise electronically.

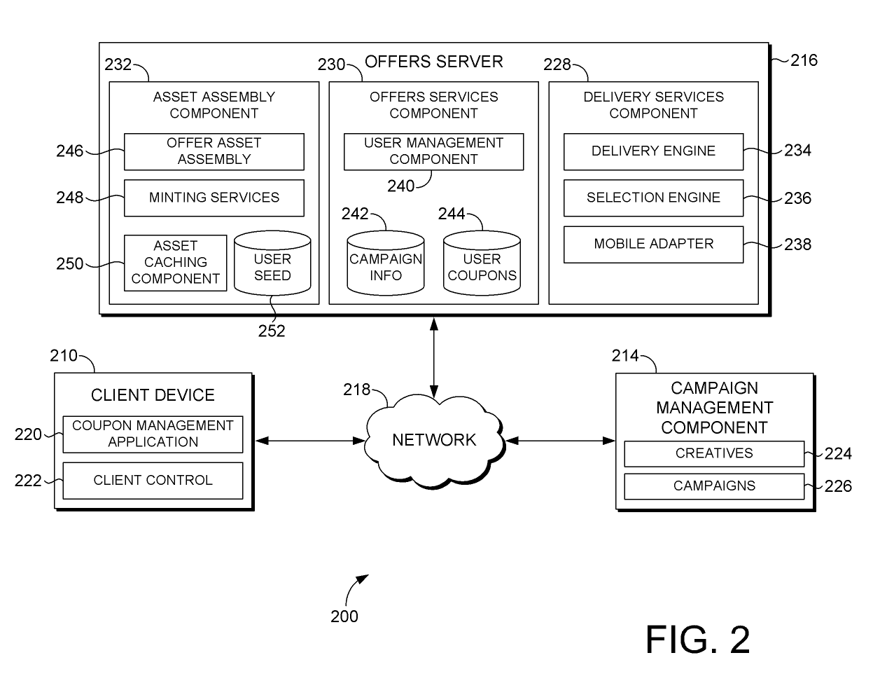

Referring now to FIG. 2, a block diagram is provided illustrating an exemplary computing system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the computing system 200 generally includes a client device 210, a campaign management component 214 and an offers server 216. The client device 210, campaign management component 214 and offers server 216 may each include any type of computing device, such as computing device 100 described with reference to FIG. 1, for example. The components of the computing system 200 may communicate with each other via a network 218, which may include, without limitation, one or more local area networks (LANs) and/or wide area networks (WANs). Such networking environments are commonplace in offices, enterprise-wide computer networks, intranets, and the Internet. It should be understood that any number of client devices, content delivery networks, campaign management components and offers servers may be employed within the computing system 200 within the scope of embodiments of the present invention. Each may comprise a single device or multiple devices cooperating in a distributed environment. For instance, the offers server 216 may comprise multiple devices arranged in a distributed environment that collectively provide the functionality of the offers server 216 described herein. Additionally, other components not shown may also be included within the computing system 200.

Generally, the system 200 illustrates an environment in which advertising entities are permitted to cap the distribution of electronic offers or coupons, monitor active electronic advertising campaigns and receive real-time feedback on the success thereof, and modify electronic advertising campaigns, while they are active, based upon at least one success metric. As will be described in further detail below, permitting advertising entities to cap distribution of electronic offers and to monitor and modify electronic advertising campaigns, while they are active, provides increased control to advertising entities that elect to advertise electronically

With continued reference to FIG. 2, the client device 210 includes a coupon management application 220 and a client control 222. The coupon management application 220 is configured to manage client interactions with electronic offers/coupons. Thus, the coupon management application 220 is configured to have the ability to perform one or more of the following functions: locally store electronic coupons and offers, present locally-stored offers and coupons, sync the state of locally-stored electronic offers and coupons with a central or remote user coupon store (user coupon store 244 of the offers server 216, more fully described below), perform a ‘redeem’ action on locally-stored electronic coupons or offers, remove electronic offers or coupons from the local store, and delete electronic coupons or offers from the remote/central user coupon store 244.

The client control 222 is configured to present a teaser associated with a requested electronic offer or coupon and to present a preview upon selection of the presented teaser. As utilized herein, a “teaser” is an advertisement (image or text) that references an associated offer with fewer specific offer details than the offer itself includes. In embodiments, teasers may be visually smaller than the corresponding offer that includes the full offer details. A preview is a content and/or content-image advertisement containing relevant offer details. In embodiments, previews are standard-size thus having larger content and/or content images than a corresponding teaser.

The client control 222 is further configured to support ‘save,’ ‘redeem,’ or ‘close’ requests with respect to a presented teaser. In this regard, the client control 222 is configured to receive ‘save’ requests based upon presented teasers and forward such requests to the offers services component 230 of the offers server 216 such that such offers/coupons are stored in association with the user coupon store 244. If no network access is available at the time a ‘save’ request is received, it may be queued for later retry.

Still further, the client control 222 is configured to receive ‘redeem’ requests for presented offers or coupons and forward such requests to the offers services 230 component of the offers server 216. The response to this request will either be a failure code or a success code with the body of the reply generally being a generated image or Uniform Resource Locator (URL). The client control 222 is also configured to present the image on success. In embodiments, the failure code indicates the nature of the failure, e.g., that a capping rule has been exceeded. Upon receipt of a ‘close’ request, the client control 222 is configured to remove the teaser and return the client application to its state prior to presentation of the teaser.

The campaign management component 214 permits advertising entities to set up the details of offers-focused advertising campaigns. The campaign management component 214 includes a creatives component 224 and a campaigns component 226. The creatives component 224 is configured to receive input of creatives associated with an offers-focused advertising campaign. Creatives may include, without limitation, base advertisements, teasers, previews and coupons. As used herein, a “base advertisement is an advertisement associated with the advertising entity that does not reference any particular offer. Base advertisements may be displayed as a product reminder when, for instance, both save and redemption limits have been met by the device requesting presentation of an offer. Thus, inclusion of a base advertisement creative in an advertising campaign allows for redemption and save caps to be met without requiring the advertisement selection engine 236 of the delivery offers server 216 (more fully described below) to retrieve another advertising campaign until, for instance, impression counts or campaign expiration dates have been reached.

As previously set forth, a “teaser” refers to an advertisement (image or text) that references an associated offer value but contains fewer specific offer details than the offer itself. In embodiments, teasers may be smaller than the corresponding advertisements that include the full offer details. A preview is a content and/or content-image advertisement containing relevant offer details. In embodiments, previews are formatted in a larger standard size thus having more content and/or content images than a corresponding teaser. A coupon is content or a content-image advertisement containing relevant offer details and a redemption code unique to a particular individual or device. Coupons are “minted” by the minting services component 248 of the offers server 216 upon receipt of a ‘redeem’ or ‘save’ event. Minting describes the process of creating all the metadata for a unique coupon. The metadata contains information about the user and the advertising campaign (and the source of an offer, as appropriate) and may be used to generate a unique offer image. Minting is more fully described below. In embodiments, coupons are standard-size thus having larger content and/or content images than corresponding teasers and/or previews.

The campaigns component 226 is configured to receive input of campaign values, including offer details and consumer targeting parameters, associated with an electronic advertising campaign. Offer details may include, without limitation, redemption capping values, distribution capping values and frequency capping values. As used herein, “capping” is a limitation assigned by the advertising entity to an advertising campaign for presentation and/or redemption of an electronic offer. Redemption capping values limit how many coupons or offers can be redeemed or saved by the same device or individual. Distribution capping values limit how many of a given offer can be collectively distributed to all devices or individuals. Frequency capping values limit the viewing of an offer or coupon by the same device or individual.

Additional offer details may include, without limitation, offer/coupon value by distance range, time usage, expiry and promotion codes, in addition to standard campaign management content. Offer/coupon value by distance range details specify the value of an offer or coupon based upon the distance of the requesting individual or device relative to the advertising entity at the time the request is received. For instance, a coupon may be valued at 50% off an item if the request is received from an individual or device located between three and five miles from the advertising entity, 25% off the item if the request is received from an individual or device located between one and two miles from the advertising entity and no coupon but merely an advertisement may be presented if the request is received from an individual or device located less than one mile or greater than five miles from the advertising entity. Offer details related to time usage may specify, for instance, that a coupon may only be redeemed during certain hours of the day or on certain days of the week. Offer details related to expiry may specify, by way of example only, that the associated offer expires at a particular time or on a particular date. In embodiments, the lower limit may be set to any reasonable length of time, for instance, not less than one hour from receipt of the request. Offer details related to promotion codes may include, by way of example only, consonant strings or numbers to be included in an associated offer's unique identifier. Generally, the position of a promotion value will be within the minted value.

Distribution capping is rules driven. Those rules can be determined by the advertising entity at the time of advertisement campaign initialization or anytime during the flight of the advertising campaign itself. Rules may be as simple as a stated number for total distribution. In embodiments, the rules may be more complex and include elements such as location (e.g., distribution percentages for a given geographic location), distance of the requesting individual or device from the advertising entity at the time the request is received (as described above), staged distribution rate step-down (e.g., algorithmically slow the rate of distribution when distribution is within a certain percentage of the distribution cap value) and staged step-down value (e.g., change the value of the offer when distribution is within a certain percentage of the distribution cap value). All such offer details, and any combination thereof, are included within the scope of embodiments of the present invention.

Elements of an advertising campaign that are entered as part of advertisement campaign management must be “printed” onto the offer image at the time of delivery. Thus, the advertising entity, as part of the offer details, may include space in a well-known and/or standard location on the advertisement type surface to allow for this real-time overlay. Alternatively, the coupon itself may be dynamically built from asset elements rather than as a single image.

Advertising campaigns may also include consumer targeting parameters. Such parameters may be targeted to an audience (demographic and behavioral targeting). In addition, offers or coupons may be targeted to specific geographic locations, applications (e.g., search-based applications), times of day (e.g., during lunch hours), and the like.

The offers server 216 includes a delivery services component 228, an offers services component 230 and an asset assembly component 232. The delivery services component 228 is configured to receive requests for offers, parse offer requests, select offers and/or advertisements satisfying requests, test capping rules, and serve appropriate advertisements and offers to requesting devices (e.g., client device 210). The delivery services component 230 includes a delivery engine 234, a selection engine 236 and a mobile adapter 238. The delivery engine 234 is configured to receive requests for offers from offers-focused advertising campaigns and to forward the received requests to the selection engine 236. The selection engine 236 is configured to receive offer requests from the delivery engine 234, to select appropriate offers and/or advertisements to return in response to a received offer request, and to return the advertisement and/or offer selection to the delivery engine. The mobile adaptor 238 is configured to receive requests for offers from the delivery engine 234 and to parse the requests to aid in determining the offer details and consumer targeting parameters to be checked before fulfilling a received request. When the capping rules are tested, the offers services component 230 dynamically creates an entry in the central ‘user coupons’ database 244, if required. If the capping rules are triggered, an error or failure response is returned to the delivery services component 228; otherwise, a success message is returned.

A ‘save’ or ‘redeem’ request results in the capping rules being tested. If any rules trigger, an error or failure message is returned. On success, the asset assembly component 232 is contacted to mint a new coupon and the resulting URL is stored locally. The response to the client device 210 is a success message. The body of the ‘redeem’ response contains the coupon image.

The offers services component 230 is configured to engage in checking capping and other rules and offer details associated with a requested electronic offer. Thus, the offers services component 230 includes a user management component 240, a campaign information store 242 and a central user coupon store 244. The user management component 240 manages user requests for electronic offers and communicates with both the delivery services component 228 and the asset assembly component 232 to request minting of coupons when appropriate. The campaign information store 242 is configured to store information associated with electronic advertising campaigns, that is, the information input by an advertising entity via the campaign management component 214. The central user coupons store 244 is configured to store information associated with specific individual users and/or client devices as it relates to coupons to which the user has access, e.g., stored coupons and the like.

The asset assembly component 232 engages in minting unique-per-user offers and delivers the corresponding text and/or images to the client. Minting describes the process of creating all the metadata for a unique coupon. The metadata contains information about the user and the advertising campaign (and the source of an offer, as appropriate) and can be used to generate a unique offer image. The asset assembly component 232 receives request for offer/coupon minting from the user management component 240. A request for minting contains user information, campaign information and the unique coupon ID. If the user information is new then a new seed value for hashing is generally generated and stored locally in the ‘user seed’ database 252. This information and the seed will be used to generate a hash and this and other information will be embedded into a URL returned to the user management component 240. The URL returned by minting can then be used to request a coupon image from the asset assembly component 232.

The asset assembly component 232 further includes an offer asset assembly component 246, a minting services component 248 and an asset caching component 250. The offer asset assembly component 246 is configured to assembly unique-per-user offers, that is, offers having unique-per-user redemption codes associated therewith. The minting services component 248 is configured to mint coupons, as more fully described below. The asset caching component 250 is configured to cache images associated with advertising campaigns to improve efficiency and decrease use of system resources.

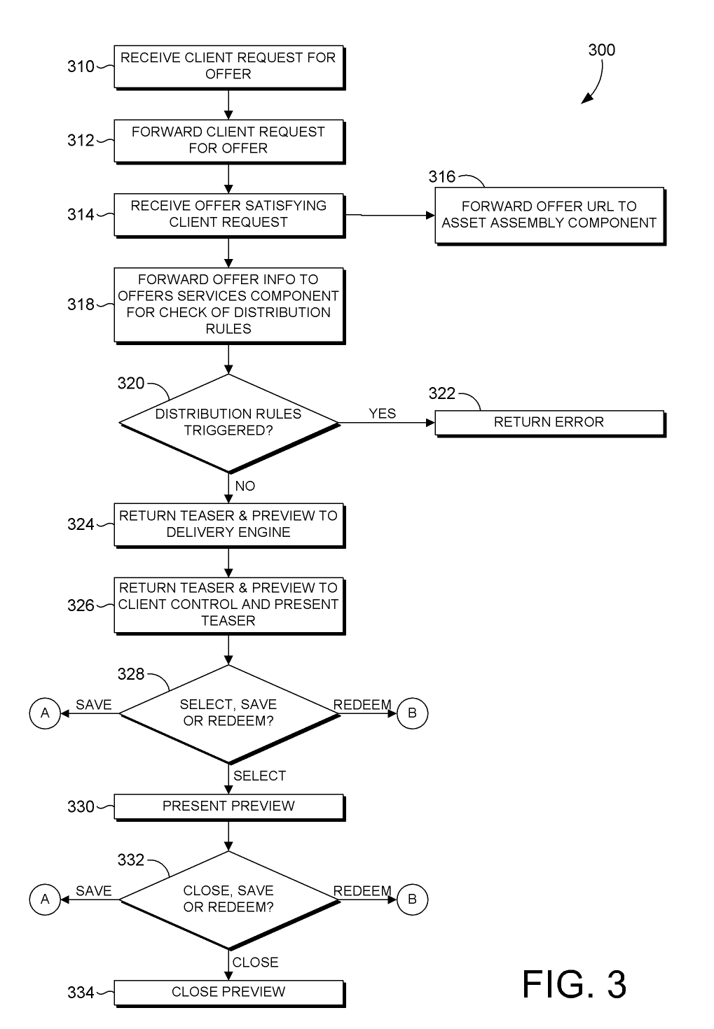

Turning now to FIG. 3, a flow diagram is provided that illustrates a method 300 for receiving a client request for an electronic offer and checking any distribution rules associated with the relevant advertising campaign before serving the requested offer, in accordance with an embodiment of the present invention. Initially, as indicated at block 310, a client request for an offer is received (e.g., from client control 222 of client device 210 to the delivery engine 234 of the offers server 216 of FIG. 2). The client request is then forwarded for selection of a satisfying offer/coupon, as indicated at block 312. By way of example, the client request may be forwarded from the delivery engine 234 to the selection engine 236 of the delivery services component 228 of FIG. 2. A satisfying offer/coupon is then selected and returned, e.g., to the delivery engine 234 of FIG. 2. This is indicated at block 314.

As indicated at block 316, the offer URL is forwarded, for instance, to the asset caching component 250 of FIG. 2. The offer information is also forwarded, for instance, to the offers services component 230 of FIG. 2, for a check of any distribution rules associated with the advertising campaign from which the satisfying offer/coupon was selected. This is indicated at block 318. As indicated at block 320, it is next determined whether any of the distribution rules would be triggered if the request for the offer/coupon was fulfilled. If any distribution rules associated with the advertising campaign would be triggered such that presentation would violate the rules, an error message is returned, for instance, to the delivery services component 228 of FIG. 2. This is indicated at block 322. In embodiments, the error message may include information about the nature of the error, e.g., “maximum distribution achieved,” “user/device distribution achieved,” or the like. Further, in embodiments, along with such an error message, or in lieu thereof, an advertisement for the associated product or service may be served that does not include a reference to the offer or coupon. Any and all such variations, and any combination thereof, are contemplated to be within the scope of embodiments of the present invention.

If, however, none of the distribution rules associated with the advertising campaign would be triggered, a teaser and a preview associated with the satisfying offer/coupon is delivered, for instance, to the delivery engine 234 of FIG. 2, as indicated at block 324. The teaser and preview are then returned to the requesting client device (e.g., delivered from delivery engine 234 to the client control 222 of the client device 210 of FIG. 2). This is indicated at block 326. Upon delivery, the teaser associated with the satisfying offer/coupon (or any other iconography, image or text indicating that an offer is available) is then presented, for instance, in association with a display screen associated with client device 210 of FIG. 2. The user may then take a number of different actions with respect to the offer/coupon, including but not limited to selecting the teaser, or saving or redeeming the offer/coupon, as indicated at block 328.

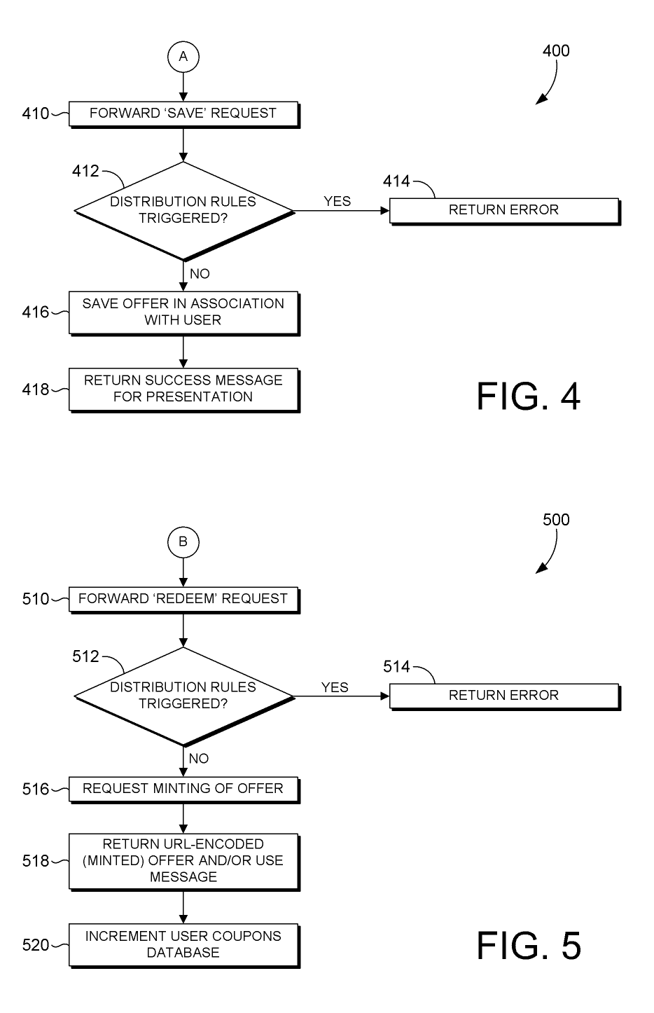

Upon receiving an indication that the user desires to save the offer/coupon, the method 300 continues as shown in FIG. 4 (more fully described below). Upon receiving an indication that the user desires to redeem the offer/coupon, the method 300 continues as shown in FIG. 5 (more fully described below). Upon receiving a user selection of the offer/coupon teaser, the preview for the offer is presented, as indicated at block 330. The user may then close the preview, save the offer/coupon or redeem the offer/coupon, as indicated at block 332. Upon receiving an indication that the user desires to save the offer/coupon, the method 300 continues as shown in FIG. 4 (more fully described below). Upon receiving an indication that the user desires to redeem the offer/coupon, the method 300 continues as shown in FIG. 5 (more fully described below). Upon receiving an indication that the user desires to close the preview, the preview is closed and the display returns to its state prior to delivery of the offer/coupon. This is indicated at block 334.

With reference to FIG. 4, a flow diagram is illustrated showing a method 400 for checking distribution rules associated with an advertising campaign upon receiving a ‘save’ request for an electronic offer, in accordance with an embodiment of the present invention. As indicated at block 410, upon receipt of a ‘save’ request (e.g., by the client control 222 of the client device 210 of FIG. 2), the ‘save’ request is forwarded, for instance, to the delivery services component 228 of the offers server 216 of FIG. 2. It is then determined whether any distribution rules would be triggered if the request for the offer/coupon was fulfilled, as indicated at block 412. If any distribution rules associated with the advertising campaign would be triggered such that saving the request would violate the rules, an error message is returned, for instance, to the delivery services component 228 of FIG. 2. This is indicated at block 414. In embodiments, the error message may include information about the nature of the error, e.g., “maximum distribution achieved,” “user/device distribution achieved,” or the like. If, however, it is determined that none of the distribution rules associated with the advertising campaign would be triggered, information associated with the offer/coupon is stored, for instance, in the central user coupons store 244 of FIG. 2. A success message is also returned for presentation in association with the requesting client device (e.g., client device 210 of FIG. 2), as indicated at block 418, that indicates that the offer/coupon was successfully stored. In embodiments, the offer/coupon is returned to the requesting client device for local storage. Any and all such variations, and any combination thereof, are contemplated to be within the scope of embodiments of the present invention.

With reference to FIG. 5, a flow diagram is illustrated showing a method 500 for minting an electronic offer associated with an advertising campaign upon receiving a ‘redeem’ request for the offer, in accordance with an embodiment of the present invention. As indicated at block 510, upon receipt of a ‘redeem’ request (e.g., by the client control 222 of the client device 210 of FIG. 2), the ‘redeem’ request is forwarded, for instance, to the delivery services component 228 of the offers server 216 of FIG. 2. It is then determined whether any distribution rules would be triggered if the request for the offer/coupon was fulfilled, as indicated at block 512. If any distribution rules associated with the advertising campaign would be triggered such that fulfilling the redeem request would violate the rules, an error message is returned, for instance, to the delivery services component 228 of FIG. 2. This is indicated at block 514. In embodiments, the error message may include information about the nature of the error. If, however, it is determined that none of the distribution rules associated with the advertising campaign would be triggered, a request for minting of the offer is sent, for instance, to the minting services component 248 of the offers server 216 of FIG. 2. This is indicated at block 516. The process of ‘minting’ was described more fully herein above. If the requesting user (individual or client device) does not have a user seed value, for instance, stored in association with the user seed database 250, (that is, if the user has not previously stored or redeemed an offer/coupon), the asset assembly component 232 will generate a seed value. The values will then be used to cryptographically generate a one way hash and are then encoded into the URL (except the seed).

Once minting is completed, the URL-encoded (minted) offer and/or a redemption message is returned, for instance, to the delivery engine 234 of FIG. 2 and then to the client device 210, as indicated at block 518. In embodiments, an offer/coupon image is presented in association with the client device that includes the unique-per-user redemption code. The central user coupons store 244 is also incremented creating a record of the coupon usage. This is indicated at block 520. If appropriate, the user seed hash is also stored.

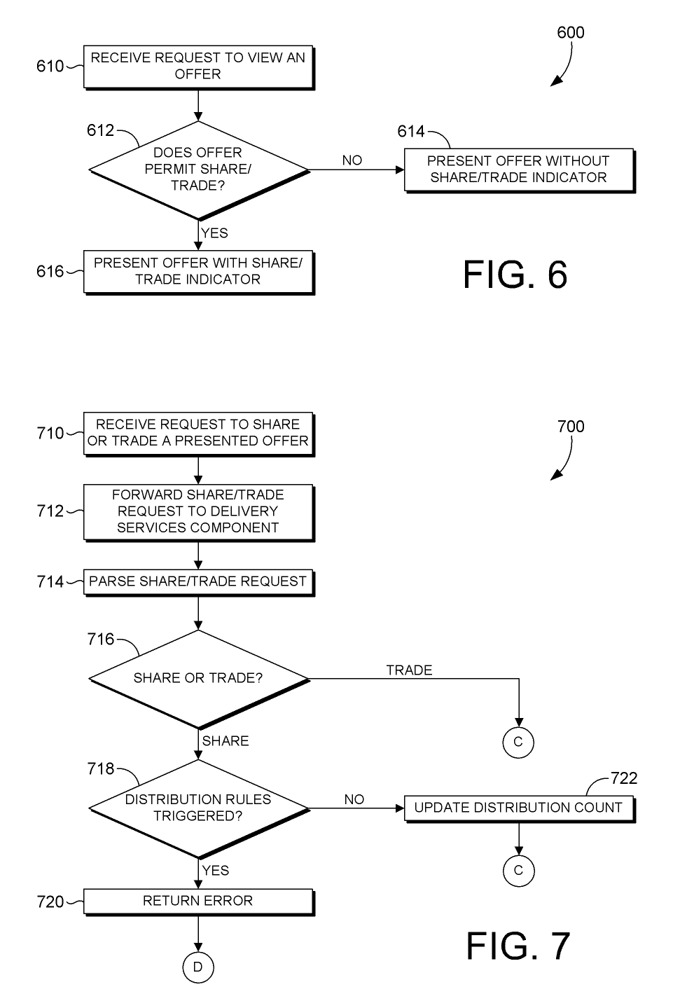

With reference to FIG. 6, a flow diagram is illustrated showing a method 600 for presenting electronic offers with share and/or trade indicators, in accordance with an embodiment of the present invention. As indicated at block 610, a request to view an offer is received, for instance, from client control 222 of the client device 210 of FIG. 2. Such a request may be received upon selection of a presented teaser, upon a request to view an offer stored in association with the user coupons database (e.g., central user coupons store 244 of FIG. 2), or the like. Next, as indicated at block 612, it is determined whether the offer permits sharing and/or trading. If it is determined that the offer does not permit sharing and/or trading, the requested offer is presented without any share or trade indicator (e.g., iconography) as indicated at block 614. If, however, it is determined at block 612 that sharing and/or trading is permitted, the requested offer is presented with a share and/or trade indicator, as indicated at block 616. In embodiments, there may be separate indicators for share permission and trade permission or a single indicator that represents that at least one of sharing and trading is permitted with respect to the presented offer.

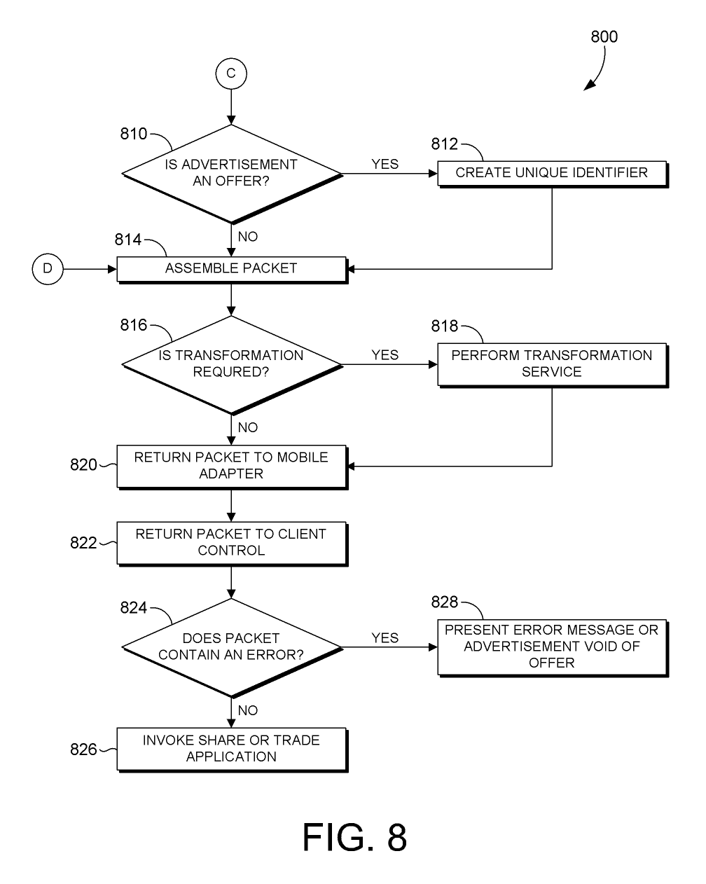

Turning now to FIG. 7, a flow diagram is illustrated showing a method 700 for checking distribution rules associated with an advertising campaign upon receiving a request to share or trade an electronic offer, in accordance with an embodiment of the present invention. As indicated at block 710, a request to share or trade a presented electronic offer is received, for instance, by client device 210 of FIG. 2. The request may be received upon user selection of a teaser, preview, share/trade indicator, menu selection, or the like. Embodiments of the present invention are not limited by the method of share/trade request receipt. Next, as indicated at block 712, the share/trade request is forwarded, for instance, to the delivery services component 228 of the offers server 216 of FIG. 2. The received request is then parsed (for instance, by the mobile adaptor 238 of FIG. 2), as indicated at block 714, and it is determined whether the received request is a share request or a trade request. This is indicated at block 716. In embodiments, if it is determined that the request is a trade request, the offer/coupon in the requestor's coupon store is marked as “traded” both on the client device and the server and a newly minted version of the offer/coupon is sent to the requested recipient. In other embodiments, a traded offer/coupon is deleted from the requestor's coupon store rather than marked as “traded.” Any and all such variations, and any combination thereof, are contemplated to be within the scope of embodiments of the present invention. The method then continues as shown at indicator C of FIG. 8.

If, however, the request is determined at block 716 to be a share request, it is determined whether any distribution rules would be triggered by sharing the electronic offer as requested. This is indicated at block 718.

If it is determined that any distribution rules associated with the advertising campaign and/or electronic offer would be violated by sharing the electronic offer as requested, an error message is returned, for instance, to the delivery services component 228 and to the client device 210 of FIG. 2. This is indicated at block 720. In embodiments the error message may indicate that a sharing error has occurred or may simply be presentation of an advertisement or the like instead of the requested offer. Any and all such variations, and any combinations thereof, are contemplated to be within the scope of embodiments of the present invention. The method then continues as shown at indicator D of FIG. 8.

If it is determined at block 718 that none of the distribution rules associated with the electronic offer or advertising campaign would be violated by sharing the electronic offer as requested, the distribution count for the electronic offer is updated, for instance, in the campaign information database 242 of FIG. 2, and the method continues as shown at indicator C of FIG. 8.

With reference to FIG. 8, a flow diagram is illustrated showing a method for sharing or trading an electronic offer, in accordance with an embodiment of the present invention. As indicated at block 810, upon determining that none of the distribution rules associated with the electronic offer or advertising campaign would be violated by sharing or trading the electronic offer as requested (see FIG. 7), it is determined whether the advertisement contains an offer or coupon. If it is determined that the advertisement does contain an offer or coupon, a unique identifier is created that is specific to the offer and to the receiving individual and/or client device. This is indicated at block 812.

Upon determining that the advertisement does not include an offer, upon creation of the unique identifier, or if the share request causes triggering of any distribution rules associated with the advertising campaign (see FIG. 7), a packet including the appropriate information for transmission is assembled, as indicated at block 814. It is then determined whether a transformation is required, as indicated at block 816. If a transformation is determined to be required, a transformation service is performed, as indicated at block 818. Upon completion of the transformation service, or if it is determined that a transformation is not required, the packet is returned to the mobile adaptor, e.g., mobile adapter 238 of FIG. 2, as indicated at block 820. The packet is then returned to the client control, e.g., client control 222 of FIG. 2, as indicated at block 822. Once at the client control, it is determined whether the packet contains any errors. Upon determining that the packet does not contain any errors, the requested share or trade application is invoked, as indicated at block 826. If, however, it is determined that the packet does contain one or more errors, an error message or advertisement void of any offer/coupon is presented to the user, e.g., on a screen display associated with client device 210 of FIG. 2. This is indicated at block 828.

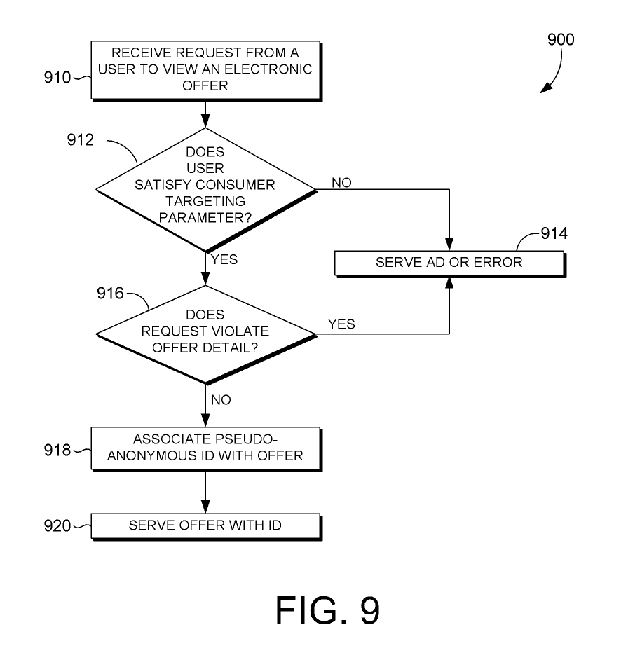

With reference to FIG. 9, a flow diagram is illustrated showing a method 900 for targeted restriction of electronic offer redemption, in accordance with an embodiment of the present invention. As indicated at block 910, a request is received from a first user to view an offer associated with a presented teaser or preview. As indicated at block 912, it is determined whether the first user satisfies at least one consumer targeting parameter associated with the corresponding electronic offer and/or the associated advertising campaign. If it is determined that fulfilling the first user does not satisfy at least one consumer targeting parameter associated with the corresponding offer and/or advertising campaign, indicating that requesting device or individual is not qualified to receive the electronic offer, an advertisement void of the electronic offer and/or an error message is stored and/or presented, for instance, in association with a screen display associated with the requesting client device. This is indicated at block 914.

If, however, it is determined at block 912 that the first user satisfies at least one consumer targeting parameter, it is determined whether fulfilling the request would violate any offer details associated with the electronic offer, as indicated at block 916. If it is determined that fulfilling the request would violate one or more offer details associated with the electronic offer, indicating that requesting device or individual should not receive the electronic offer, an advertisement void of the electronic offer and/or an error message is stored and/or presented, for instance, in association with a screen display associated with the requesting client device. This is indicated at block 914. If it is determined that fulfilling the request would not violate any offer details associated with the electronic offer and/or the associated advertising campaign, a pseudo-anonymous identifier is associated with the electronic offer, the pseudo-anonymous identifier associating the electronic offer with the first user. This is indicated at block 918. The electronic offer having the pseudo-anonymous identifier associated therewith is then served to the requesting computing device and/or individual, as indicated at block 920.

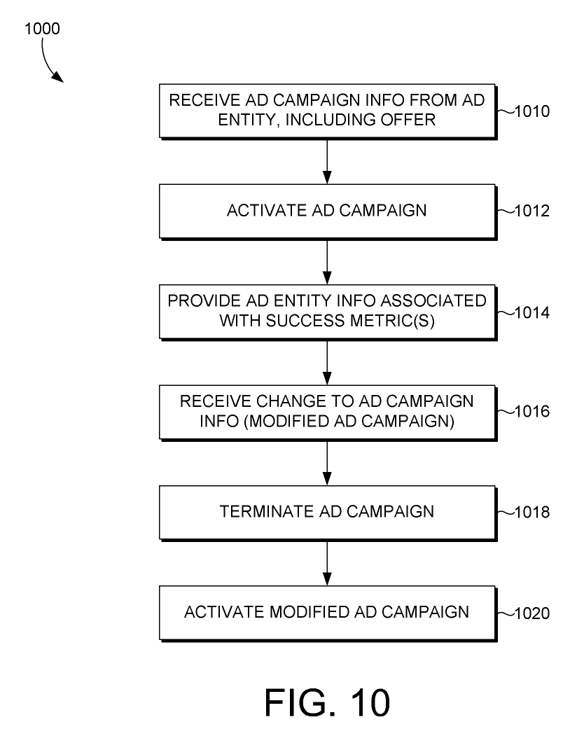

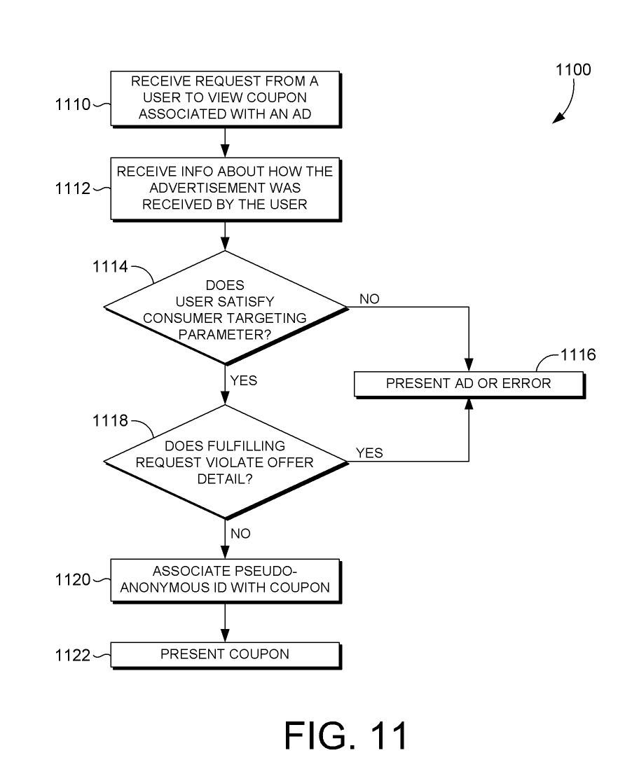

With reference to FIG. 10, a flow diagram is illustrated showing a method 1000 for performing targeted restriction of electronic offer redemption, in accordance with an embodiment of the present invention. As indicated at block 1010, information is received from an advertising entity, the information being associated with an advertising campaign, the advertising campaign including at least one offer, and the at least one offer having one or more offer details associated therewith. Next, as indicated at block 1012, the advertising campaign is activated in accordance with the one or more offer details. While the advertising campaign is active, the advertising entity is provided information associated with at least one success metric of the advertising campaign, as indicated at block 1014. Each of the at least one success metrics my be any quantitative figure that would aid the advertising entity in judging the success or failure of the electronic advertising campaign including, but not limited to, a number of electronic offers distributed, an average distance from a retail location of individuals and/or client devices to whom the electronic offer has been served, the number of shares of the electronic offer, and the like.

As indicated at block 1016, while the advertising campaign is active, the method of FIG. 10 further includes receiving a change to at least one of the one or more offer details associated with the advertising campaign to create a modified advertising campaign. For instance, suppose the advertising campaign includes an electronic coupon for $0.50 off a particular item. Now suppose that the advertising entity receives a success metric indicating that the coupons are being traded, shared or otherwise distributed at a rate much faster than anticipated. The advertising entity may change the offer detail that specifies $0.50 off to $0.25 off so as not to exceed its anticipated profit loss due to the advertising campaign.

Upon receipt of the change to the offer detail(s), the original advertising campaign is terminated, as indicated at block 1018, and the modified advertising campaign is then activated, as indicated at block 1020.

With reference to FIG. 11, a flow diagram is illustrated showing a method 1100 for targeted restriction of electronic offer redemption, in accordance with another embodiment of the present invention. As indicated at block 1110, a request is received from a first user to view an electronic coupon associated with an advertisement. As indicated at block 1112, information regarding how the advertisement was received by the first user is also received. For instance, the advertisement may have been received by the first user directly from the advertising entity, shared with the first user by a second user, traded with the first user, or the like.

As indicated at block 1114, it is determined whether fulfilling the first user satisfies at least one consumer targeting parameter. If it is determined that the first user does not satisfy at least one consumer targeting parameter associated with the coupon and/or associated advertising campaign, indicating that requesting device or individual is not qualified to receive the electronic coupon, an advertisement void of the electronic coupon and/or an error message is stored and/or presented, for instance, in association with a screen display associated with the requesting client device. This is indicated at block 1116.

If, however, it is determined at block 1114 that the first user satisfies at least one consumer targeting parameter, it is determined whether fulfilling the request would violate any offer details associated with the electronic coupon, as indicated at block 1118. If it is determined that fulfilling the request would violate one or more offer details associated with the electronic coupon, indicating that requesting device or individual should not receive the electronic coupon, an advertisement void of the electronic coupon and/or an error message is stored and/or presented, for instance, in association with a screen display associated with the requesting client device. This is indicated at block 1116. If it is determined that fulfilling the request would not violate any offer details associated with the electronic coupon and/or the associated advertising campaign, a pseudo-anonymous identifier is associated with the electronic coupon, the pseudo-anonymous identifier associating the electronic coupon with the first user and the information regarding how the electronic coupon was received by the first user. This is indicated at block 918. The electronic offer having the pseudo-anonymous identifier associated therewith is then served to the requesting computing device and/or individual, as indicated at block 110. At least a preview of the electronic coupon is then presented to the user, for instance, in association with a screen display associated with the requesting client device. This is indicated at block 1122.

As can be understood, embodiments of the present invention provide advertising entities the ability to cap the distribution of electronic offers or coupons. Embodiments of the present invention further permit advertising entities to monitor active electronic advertising campaigns and receive real-time feedback on the success thereof. Still further, embodiments of the invention permit advertising entities to modify electronic advertising campaigns, while they are active, based upon at least one success metric. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-readable storage media storing computer-useable instructions that, when used by one or more computing devices, causes the one or more computing devices to perform a method for targeted restriction of electronic offer redemption, the method comprising:
receiving a request from a first user to view an electronic offer;
determining whether the first user satisfies at least one consumer targeting parameter;
determining whether fulfilling the request violates an offer detail associated with the electronic offer;
upon determining that the first user satisfies at least one consumer targeting parameter and that fulfilling the request does not violate an offer detail associated with the electronic offer, associating a pseudo-anonymous identifier with the electronic offer, the pseudo-anonymous identifier associating the electronic offer with the first user; and
serving the electronic offer having the pseudo-anonymous identifier associated therewith to a computing device associated with the first user.

2. The one or more computer-readable media of claim 1, wherein the method further comprises:
receiving a request from the first user to redeem the electronic offer; and
presenting an image of the electronic offer having the pseudo-anonymous identifier associated therewith on a display screen associated with the computing device.

3. The one or more computer-readable media of claim 2, wherein the method further comprises storing information associated with the electronic offer in an offer storage location associated with the first user.

4. The one or more computer-readable media of claim 3, wherein the method further comprises:
receiving a view request from the first user to view information associated with the electronic offer;
querying the offer storage location associated with the first user for the information for which viewing was requested; and
presenting the information associated with the electronic offer on the display screen associated with the computing device.

5. The one or more computer-readable media of claim 4, wherein the method further comprises:
receiving an expanded information request from the first user regarding the electronic offer presented on the display screen; and
presenting an expanded image of the electronic offer having the pseudo-anonymous identifier associated therewith on the display screen, wherein the expanded image contains more information than the first image of the electronic offer and/or comprises a larger image than the first image.

6. The one or more computer-readable media of claim 1, wherein the method further comprises:
receiving a request from the first user to store the electronic offer; and
presenting an acknowledgement indicating that the electronic offer has been stored to an offer storage location associated with the first user.

7. The one or more computer-readable media of claim 6, wherein the method further comprises:
receiving a view request from the first user to view information associated with the electronic offer;
querying the offer storage location associated with the first user for the information for which viewing was requested; and
presenting the information associated with the electronic offer on a display screen associated with the computing device.

8. The one or more computer-readable media of claim 7, wherein the method further comprises:
receiving a redemption request from the first user to redeem the electronic offer presented on the display screen; and
presenting an image of the electronic offer having the pseudo-anonymous identifier associated therewith on the display screen.

9. The one or more computer-readable media of claim 1, wherein the offer detail includes one or more of an expiration date for the electronic offer, an expiration time for the electronic offer, a maximum number of the electronic offer to be served to any user, and a maximum number of the electronic offer to be served to the first user.

10. The one or more computer-readable media of claim 1, wherein the consumer targeting parameter includes a location of the first user when the request to view the electronic offer is received.

11. The one or more computer-readable media of claim 1, wherein the method further comprises receiving information regarding how the electronic offer was received by the first user.

12. The one or more computer-readable media of claim 11, wherein the pseudo-anonymous identifier further associates the electronic offer with the information regarding how the electronic offer was received by the first user.

13. The one or more computer-readable media of claim 1, wherein the offer detail includes an identity of at least one person or entity from whom distribution of the electronic offer is not permitted.

14. One or more computer-readable media storing computer-useable instructions that, when used by one or more computing devices, causes the one or more computing devices to perform a method for targeted restriction of electronic offer redemption, the method comprising:
receiving information from an advertising entity, the information being associated with an advertising campaign, the advertising campaign including at least one offer, and the at least one offer having one or more offer details associated therewith;
activating the advertising campaign in accordance with the one or more offer details;
while the advertising campaign is active, providing to the advertising entity information associated with at least one success metric of the advertising campaign;
while the advertising campaign is active, receiving a change to at least one of the one or more offer details associated with the advertising campaign to create a modified advertising campaign;
terminating the advertising campaign; and
activating the modified advertising campaign.

15. The one or more computer-readable media of claim 14, wherein the at least one offer includes a coupon.

16. The one or more computer-readable media of claim 14, wherein the one or more offer details includes one or more of an expiration date for the at least one offer, an expiration time for the at least one offer, a maximum number of the at least one offer to be served to any user and a maximum number of the at least one offer to be served to a particular user.

17. The one or more computer-readable media of claim 14, wherein the advertising campaign further includes at least one consumer targeting parameter.

18. The one or more computer-readable media of claim 17, wherein the consumer targeting parameter includes a location of a consumer when the at least one offer is served to that consumer.

19. A method for targeted restriction of electronic coupon redemption, the method comprising:
receiving a request from a first user to view an electronic coupon associated with an advertisement;
receiving information regarding how the advertisement was received by the first user;
determining, utilizing a first computing process, whether the first user satisfies at least one consumer targeting parameter associated with the electronic coupon;
determining, utilizing a second computing process, whether fulfilling the request violates an offer detail associated with the electronic coupon;
upon determining that the first user satisfies at least one consumer targeting parameter associated with the electronic coupon and that fulfilling the request does not violate an offer detail associated with the electronic coupon, associating, utilizing a third computing process, a pseudo-anonymous identifier with the advertisement, the pseudo-anonymous identifier associating the electronic coupon with the first user and the information regarding how the electronic coupon was received by the first user; and
presenting at least a preview of the electronic coupon,
wherein the first, second and third computing processes is performed by one or more computing devices.

20. The method of claim 19, wherein the consumer targeting parameter includes a location of the first user when the request to view the electronic coupon is received.
